(19) United States
(12) Patent Application Publication
(10) Pub. No.: US 2020/0148956 A1
(43) Pub. Date: May 14, 2020

(54) DELAYED COKER VAPOR LINE COKE LANCING

(71) Applicant: ExxonMobil Research and Engineering Company, Annandale, NJ (US)

(72) Inventors: Mitchell J. Moloney, Houston, TX (US); Sebastian K. Seider, The Woodlands, TX (US)

(21) Appl. No.: 16/185,063

(22) Filed: Nov. 9, 2018

(51) Int. Cl. C10B 33/00; C10B 43/08; B08B 3/02; C10G 75/00

(52) U.S. Cl. CPC C10B 33/006; C10G 75/00; B08B 3/024; C10B 43/08

(57) ABSTRACT

Systems and methods are provided for coke removal from the coke drum vapor line and/or other conduits between the coke drum and a coker product separation stage, such as a fractionator. A hydro-lance is inserted above the coke drum vapor line in the region where coke removal is desired. The hydro-lance can be inserted through a port, so that the lance is not present during coker operation. The hydro-lance can remove coke from the coke drum line during the water quench (flooding) stage of the coke drum process and/or during the draining step following the quench water cooling step of the coke drum.

### FIELD

Systems and methods are provided for removal of coke from vapor lines in a delayed coking system.

### BACKGROUND

Coking is a carbon rejection process that is commonly used for upgrading of heavy oil feeds and/or feeds that are challenging to process, such as feeds with a low ratio of hydrogen to carbon. In addition to producing a variety of liquid products, typical coking processes can also generate a substantial amount coke. Because the coke contains carbon, the coke is potentially a source of additional valuable products in a refinery setting. However, fully realizing this potential remains an ongoing challenge.

Thermal coking processes in modern refinery settings can typically be categorized as delayed coking or fluidized bed coking. Fluidized bed coking is a petroleum refining process in which heavy petroleum feeds, typically the non-distillable residues (resids) from the fractionation of heavy oils are converted to lighter, more useful products by thermal decomposition (coking) at elevated reaction temperatures, typically 480° C. to 590° C., (˜900° F. to 1100° F.) and in most cases from 500° C. to 550° C. (˜930° F. to 1020° F.). Heavy oils which may be processed by the fluid coking process include heavy atmospheric resids, petroleum vacuum distillation bottoms, aromatic extracts, asphalts, and bitumens from tar sands, tar pits and pitch lakes of Canada (Athabasca, Alta.), Trinidad, Southern California (La Brea (Los Angeles), McKittrick (Bakersfield, Calif.), Carpinteria (Santa Barbara County, Calif.), Lake Bermudez (Venezuela) and similar deposits such as those found in Texas, Peru, Iran, Russia and Poland.

One of the challenges during coking is maintaining desired coking conditions to enhance the product slate while reducing or minimizing accumulation of coke outside of desired locations. For example, in a delayed coker, the goal of the coking process is to form coke within the coker drum while the remaining coking products exit as a gas phase through a coke drum vapor line. Unfortunately, the temperature of the products exiting through the coke drum vapor line is typically high enough so that some coking also occurs in the coke drum vapor line. As this coke accumulates, the available cross-section in the coke drum vapor line is reduced, leading to an increased pressure drop for gases exiting from the coker drum. The resulting increased coke drum pressure increases coke production and reduces ultimate liquid product yields.

Various methods have been employed to minimize coke deposition inside the vapor lines. One method is injection of quench oil (hydrocarbon) or slop oil (hydrocarbon, water and solids) into a well-insulated and shielded vapor line in order to drop the temperature on the order of 12-24° C. (20-40° F.). This reduces the rate of thermal cracking and the formation rate of coke within the piping; effectively slowing the rise in coke drum pressure. A second method is to install stand-off shielding around uninsulated vapor piping. This method allows condensation of the dew point vapor on the inner wall of the vapor piping, preventing coke deposition. These methods can reduce the build-up of coke on the inner pipe walls and slow the increase in coke drum pressure with time. However, despite these design features, coke can still build up in the vertical vapor piping upstream of the first 90° turn in the piping. An annulus of coke forms, often referred to as a “coke donut”, which gradually becomes a significant orifice restriction to flow, causing much higher coke drum pressure.

The extent and rate at which such “donuts” form generally depends on the back-mix flow turbulence that is created, which is influenced by the quench inlet piping and nozzle arrangement, the location of temperature measurement thermowells, the coking temperature, the extent of coke drum foam carryover, and the flow velocities in play. The “donut” is typically removed using high-pressure water blasting, which requires that the vapor line clean-out flanges be opened.

Often, coker operators will wait for an opportunity slow-down period in order to remove the coke “donut,” which avoids having to reduce feed rate, but incurs unwanted liquid yield debits during the waiting period. If the coke “donut” pressure drop becomes too high, a feed rate reduction is unavoidable, since coke drum pressure can approach pressure relief valve set point, in some cases. Frequency of coke “donut” hydro-lancing can typically vary from a few weeks to many months, with financial yield and feed rate debits varying, depending on the situation.

Conventionally, coke removal from the coke drum vapor line is labor intensive and requires exposing the operators to the open drum line environment. This job is done using specialty equipment and trained technicians wearing protective equipment. It would be desirable to provide a method for removing coke from the coke drum vapor lines that eliminates or minimizes down time for the coke drum train during this coke removal process, eliminates exposure of workers to the open vapor piping, and reduces the amount of mechanical work needed to perform the hydro-lancing task safely.

U.S. Pat. No. 3,920,537 describes methods of removing coke from cyclone discharge nozzles and associated vapor lines in a fluidized coking unit. During operation, cold water is injected into a cyclone discharge nozzle (or a vapor line) using a hydro lance at a pressure of roughly 34.5 MPa-g (˜5000 psig) or more to thermally shock the coke. This results in breakup and dislodgement of the coke. During this operation, the feed and steam rates in the fluidized coker are reduced to compensate for the additional water vapor created due to injection of water into the cyclone. It is noted that the resulting coke particles and water vapor exit from the cyclones or vapor lines co-current with the particles and hydrocarbon/water vapor entering the cyclone from the fluidized coking environment.

U.S. Pat. No. 8,377,231 describes a more recent method for removing coke from product exit lines of a fluidized coker. An elongated flexible conduit is inserted through an elongated rigid conduit into the vessel. The conduit can be used to conduct pressurized fluid, such as water, into the vessel for break-up and removal of coke from product exit lines.

### SUMMARY

In some aspects, a method for performing coke removal is provided. The method can include exposing a feedstock to delayed coking conditions in a coke drum of a coking reaction system. The coking reaction system can include the coke drum, a coke drum vapor line, and a separation stage. The coke drum vapor line can provide fluid communication between the coke drum and the separation stage. The delayed coking conditions can result in coke formation in at least an initial portion of the coke drum vapor line. After the exposing, steam can be injected into the coke drum, and cooling water can be introduced into the coke drum. At least a portion of the cooling water from the coke drum can then be drained. A hydro-lance can be inserted into the initial portion of the coke drum vapor line. The hydro-lance can include one or more nozzles, openings, or a combination thereof. The coke formed in the initial portion of the coke drum vapor line can be contacted with water sprayed from the one or more nozzles, openings, or a combination thereof. The water can be sprayed at a pressure of 17-138 MPa-g (2500-20,000 psig) or more and/or a flow rate of 19-190 liter/min (5-50 gpm) or more. The contacting of the coke can be at least partially performed during the injecting of steam, during the introducing of the cooling water, during the draining, or a combination thereof.

In some aspects, a delayed coking system is also provided. The delayed coking system can include a coke drum. The coke drum can include a feedstock inlet and a coke drum vapor outlet. The system can further include a coke drum vapor line. The coke drum vapor line can include an initial portion, one or more additional portions, and a coke drum vapor line outlet. The initial portion of the coke drum vapor line can be in fluid communication with the coke drum vapor outlet. The system can further include a packing gland, including a packing gland opening in a wall of the initial portion of the coke drum vapor line. The system can further include a hydro-lance including one or more nozzles, openings, or a combination thereof. The hydro-lance can be configured to move from a first position within the packing gland to one or more positions at least partially located within the initial portion of the coke drum vapor line. Optionally, the hydro-lance can move from the first position to the one or more positions by passing through the packing gland opening. Additionally, the system can include a separation stage in fluid communication with the coke drum vapor line outlet. The coke drum vapor line can provide fluid communication between the coke drum and the separation stage.

### BRIEF DESCRIPTION OF THE DRAWINGS

FIG. 1 shows an example of a coke drum vapor outlet pipe with typical coke build-up, quench oil injection piping and an inserted high-pressure water lance.

FIG. 2 shows an example of a high-pressure water lance with packing gland.

FIG. 3 shows an example of one type of high-pressure water lance when inserted in the vapor outlet piping, in one possible orientation.

### DETAILED DESCRIPTION

All numerical values within the detailed description and the claims herein are modified by “about” or “approximately” the indicated value, and take into account experimental error and variations that would be expected by a person having ordinary skill in the art.

### Overview

In various aspects, systems and methods are provided for coke removal from the coke drum vapor line and/or other conduits between the coke drum and a coker product separation stage, such as a fractionator. A hydro-lance is inserted above the coke drum vapor line in the region where coke removal is desired. In some aspects the hydro-lance can be inserted parallel to the axis of the coke drum vapor line, but any other convenient orientation for the hydro-lance that allows for coke removal can be used. The hydro-lance can be inserted through a port, so that the lance is not present during coker operation. The lance is inserted during the coke removal process for a given coke drum. It has been conceived that coke removal from a coke drum vapor line can be performed during various stages of the coke removal process for the coke drum without extending the time required for said coke removal. This can be achieved by using the hydro-lance to remove coke from the coke drum line during the water quench (flooding) stage of the coke drum process and/or during the draining step following the quench water cooling step of the coke drum. The water and coke pieces formed during the hydro-blast coke removal from the coke drum vapor line can optionally but preferably fall back into the coke drum. This can allow the coke removed from the coke drum vapor line and the associated hydroblast water to exit from the coking system at the end of the quench and/or during the subsequent cutting and removal of coke from the coke drum. Optionally, the coke and water can be allowed to enter the downstream vapor piping, but this would require draining of the water and/or allowing the coke to flow to downstream equipment.

Rather than performing hydro-blast coke removal during a special maintenance window time period, which typically requires a longer coking cycle for the sister drum(s) and associated feed rate reduction, it has been discovered that feed rate reductions or uneconomic yield losses can be reduced and/or avoided by performing coke removal from the drum line during the coke bed water cooling phase or coke bed water drain phase of the coke drum decoking phase.

In a delayed coker unit, coke forms to varying degrees throughout the coke drum vapor line, between the coke drum and main fractionator. The extent and rate of coke formation is a function of facilities design, operating temperature, operating pressure, process velocities in the coke drum and piping, composition of the vapor, etc. One location where coke can accumulate at to a relatively rapid rate is in the vertical pipe riser leaving the coke drum prior to the first 90° elbow. The coke at this location can tend to form a “donut” of coke on the walls of the pipe. As the coke donut accumulates, this coke can substantially restrict vapor flow in the coke drum vapor line.

Conventionally, removal of the coke donut requires the vapor line flanges to be opened, so that the coke can be removed by a worker holding a high-pressure hydroblasting tool. Since this requires a slowdown in operational rate, in order to create a “time window” for this work, delayed coker unit operators typically will accept some growth in coke drum operating pressure prior to cleaning. These hydroblasting or “coke cutting” events can last 12 hours, requiring feed rate to be reduced by 50% during that time period. The frequency of such events is from monthly to annually, typically, depending on many factors.

In various aspects, performing “on-line” cleaning to remove at least a portion of the coke in the vertical pipe riser leaving the coke drum can reduce or minimize the growth in pressure due to formation of the coke donut, and therefore can reduce or minimize the associated yield loss. For example, by performing hydro-lancing of the coke donut during the coke drum draining step, the removed coke and hydroblast water can fall into the coke drum, which already contains water and coke. It is noted that coke obstructions can also form at other pipe bends in the vapor line, depending on the facilities design. Optionally, on-line hydro-lancing can be applied at such additional locations, with the caveat that additional handling of coke and water may be necessary for hydro-lancing at other locations. Use of this on-line process to remove the coke “donut” and other coke in the vertical vapor line pipe can reduce, minimize, or eliminate the need to increase cycle time in order to create a maintenance window time period that allows opening of the piping system for hydroblasting.

Performing coke removal from the coke drum vapor line during the quench, cooling, and/or drain step of coke removal for the coker drum can provide two types of improvements in on-line time for a coker. First, the desired feed rate and/or a feed rate closer to the desired feed rate can be maintained during the coking process. The coke that accumulates in the initial portion of a coke drum vapor line tends to have a roughly annular or “donut” shape. As coke accumulates, the available cross-sectional area in the coke drum vapor line decreases. This can lead to a corresponding increase in pressure drop as the product vapors pass through the various portions of the coke drum line. When using a maintenance schedule that involves, for example, removal of coke from the coke drum vapor line every two weeks, the resulting pressure drop in the coke drum vapor line at the end of the coking process prior to maintenance can be from ˜10 kPa (˜2 psi) to ˜100 kPa (˜15 psi) or possibly still higher. The total operating pressure in the coke drum of a delayed coker is typically ˜69 kPa-g to ˜240 kPa-g (10 psig to 35 psig), but can be as high as ˜550 kPa-g or ˜690 kPa-g (80 psig or 100 psig) for cokers making specialty coke. Thus, the pressure drop in the coke drum vapor line can correspond to a substantial portion of the total pressure in the coke drum. As a result, the pressure drop in the coke drum line can result in a significant change in operation in the coke drum due to the unfavorable shift in vapor-liquid equilibrium. This can result in a loss of liquid yield and an associated increase in gas and coke production until the coke can be removed from the coke drum vapor line.

In various aspects, by removing coke from the initial portion of the coke drum vapor line, the desired feed rate into the delayed coker and the associated liquid yields can be maintained between planned train maintenance shutdowns. Although coke can form on other surfaces in the coke drum vapor line and/or between the coke drum and the product separation stage, it has been determined that, typically, the largest accumulation is in the initial portion of the coke drum vapor line before the first turn, elbow, or other angular bend in the drum line conduit. By removing at least a portion of the coke from the initial portion of the coke drum vapor line during the quench and/or drain steps of the coke drum coke removal phase, the total pressure drop in the coke drum vapor line can be maintained at a low level, allowing enhanced economic operations between planned train maintenance shutdowns. For example, in a conventional coking system the coke drum pressure can increase 35 to 103 kPa (5 to 15 psi) over weeks to months, resulting in a 0.5 to 1.5 wt % loss in liquid yields, assuming that feed rate can be maintained. By contrast, using a hydro-lance technique to remove coke during the coke drum decoking phase on an as-needed basis, can reduce the final pressure drop build over the run between planned train maintenance shutdowns (1 to 10 years) to 7 to 35 kPa (1 to 5 psi).

The ability to retract the lance during coking can reduce or minimize coke formation on the lance, which could cause plugging of the lance. Using a retractable lance can also assist with performing the coke removal from the coke drum vapor line in a sufficiently fast manner to avoid extending the time for the coke drum decoking process. Additionally, by performing the coke removal during the quench and/or draining phase of coke drum decoking, the difficulties associated with having water and coke pieces enter the coker drum can be eliminated.

Integration of Coke Drum Vapor Line Coke Removal with the Coke Drum Decoking Phase

In various aspects, removal of coke from a coke drum vapor line can be performed during the quench and/or drain portion of the overall coke drum decoking phase. During coke removal from a coke drum, two types of water injection are used as part of the coke bed removal process. First, the coke in the coke drum is stripped with steam in order to recover residual hydrocarbon product to either the main fractionator tower or the coker blowdown system. The coke drum is then quenched by pumping liquid water into the bottom of the coke drum. The coke drum is then drained to remove the accumulated (non-vaporized) quench water from the coke drum. After draining, a “hydraulic decoking system”, such as a system using high-pressure water corresponding to 13.8 MPa-g to 138 MPa-g (2000 to 20,000 psig), is used to “cut” the coke out of the coke drum.

The quench and drain portions of the coke drum decoking process can take from 2.0 to 8.0 hours, depending on feed type and facilities. In various aspects, removal of coke from the coke drum vapor line can be performed during the quench and/or drain steps of the coke drum decoking phase. Optionally, on-line removal of coke from the coke drum vapor line could also be performed during any other steps in the coke bed decoking phase, but performing removal during the quench and/or drain steps is preferred for various practical reasons, including safety considerations.

In various aspects, the coke accumulated in the coke drum vapor line can be removed by using a high-pressure water jet or spray, of various flow rates. Because the coke that forms upstream of the first change-in-direction (i.e., first angular bend) of the vertical coke drum vapor line is typically of an annular shape, a hydro-lance can be inserted into the coke drum vapor line from above, such as by inserting the hydro-lance roughly in parallel to the central axis of the coke drum. Alternatively, the axis for insertion of the hydro-lance can correspond to any other convenient axis or angle that allows for coke removal. Optionally, the distance of insertion of the hydro-lance can be varied to allow for removal of coke at different heights within the coke drum vapor line. Optionally, one or more of the nozzles or openings for spray of water against the coke can be oriented at an angle different from perpendicular to the axis of insertion. Optionally, one or more of the nozzles or openings can be manipulated to vary the angle during coke removal.

In some alternative aspects, a flexible lance could be used, so that the lance could be inserted from the side of the coke drum vapor line conduit. In such aspects, the flexible lance can optionally be inserted so that the nozzles and/or openings for water discharge from the lance are roughly aligned with the central axis of a given section of the coke drum vapor line.

In some aspects, the lance can include a spray tip that includes one or more nozzles or openings. The spray tip can optionally rotate around the axis of insertion to allow a smaller number of nozzles or openings to effectively remove coke around the entire inner surface of the coke drum vapor line. Optionally, the spray tip and/or the nozzles on the spray tip can be at least partially rotated along a second axis different from the axis of insertion to allow for removal of coke at different heights within the coke drum vapor line.

A spray tip and/or other opening for ejecting water from a hydro-lance can include any convenient number of nozzles and/or other openings for ejection of high pressure streams of water again desired surfaces with a coke layer. The nozzles (and/or openings) can be oriented at any convenient angle. The high pressure water stream(s) from a lance and/or spray tip can be ejected at a pressure of ˜17 MPa-g (2500 psig) or more, or ˜35 MPa-g (5000 psig) or more, or ˜69 MPa-g (10,000 psig), such as up to ˜138 MPa-g (20,000 psig) or possibly still higher. The rate of water flow in a high pressure water stream for coke removal can be ˜19 liter/min (5 gal/min) or more, or ˜38 liter/min (10 gal/min) or more, or ˜75 liter/min (20 gal/min) or more, or ˜190 liter/min (50 gal/min) or more, up to ˜750 liter/min (200 gal/min) or possibly still higher. Water rates can be adjusted depending on when in the coke drum decoking cycle the hydroblast operation occurs. The highest water rates would be permissible during the coke bed drain step, following completion of coke bed cooling. It is noted that the water flow rates for the high pressure water stream refer to the water flow rate for a single stream. A hydro-lance including multiple nozzles can include at least one nozzle (such as a plurality of nozzles) that spray water at the pressure and flow rate described herein. Examples of suitable nozzles are ROTOMAG self-rotating pipe cleaning nozzles available from Jetstream of Houston, LLP.

When not in use for coke removal from the coke drum vapor line, the hydro-lance can be withdrawn from the coker drum vapor line in various ways. It can be retracted beyond a double-block-and-bleed assembly and left in place or it can be removed completely and placed in a convenient storage location. The nature of the configuration can depend, for example, on the facilities layout for a given delayed coker installation. The packing gland is part of the lance assembly and is outside the double-block-and-bleed assembly. This can reduce or minimize the likelihood of coke forming on the surface(s) of the hydro-lance. Yet another option is to leave the lance in a recessed piping enclosure with a purge stream (examples being steam and nitrogen) maintained through the recessed area and around the lance when not in use to reduce or minimize coke formation on the lance in the retracted recess area.

In some aspects, additional hydro-lances can be used for coke removal in other portions of a coke drum vapor line. The additional hydro-lances can be used in a similar manner, with the lance being inserted roughly along the central axis of the desired portion of the coke drum vapor line. However, for other downstream portions of the coke drum vapor lines (e.g., to the main fractionator, to coker blowdown, to the coke drum vents, to coke drum steam ejectors, to water over lines, or to other locations), resulting coke pieces and water associated with hydro-blasting may not flow back into the coke drum based on the geometry of the coke drum outlet piping. If the coke particles and water will flow to another location within the coking system, different from the coke drum, additional features may be needed to reduce or minimize the likelihood of the coke and water entering the downstream fractionation or separation stages. For example, for removal of coke from additional portions of the coke drum vapor line after the first 90° bend in the line, it may be beneficial to add an additional downstream port prior to the fractionator. The port can then be opened during removal of coke to allow the coke pieces and water to exit from the piping system.

It is noted that hydro-lancing to remove coke could potentially be performed at other times during a delayed coking cycle, although this could require consideration of additional factors. For example, one option could be to perform hydro-lancing to remove coke during the performance of delayed coking on a feed or process fluid. This is typically not preferred, as this would require insertion and/or operation of the lance while process fluid is within the delayed coker unit. Additionally, performing hydro-lancing during operation of the delayed coker can potentially impact the operation, while performing hydro-lancing during quenching and/or draining avoids the impact on operation. However, if hydro-lancing is performed during the coking process, the resulting water and coke fragments could be handled by selecting an insertion location for the hydro-lance so that the water and coke fragments fall back into the coker drum. In such an aspect, the water use can be limited to avoid excessive quenching in the coker drum. The water could then exit the delayed coking system as steam. The coke fragments would remain in the coker drum until the next coke cutting operation.

Other examples of times when hydro-lancing could be performed can include other types of maintenance events, either scheduled or unscheduled, where the hydro-lancing can be carried out while reducing or minimizing safety concerns. It is noted that although hydro-lancing can be performed during quenching and draining of the coker drum, performing the hydro-lancing during coke cutting in the coker drum is not preferred in order to reduce or minimize variables that need to be considered for maintaining safe operating procedures during the coke cutting process.

### Example Configuration for Coke Drum Line Coke Removal

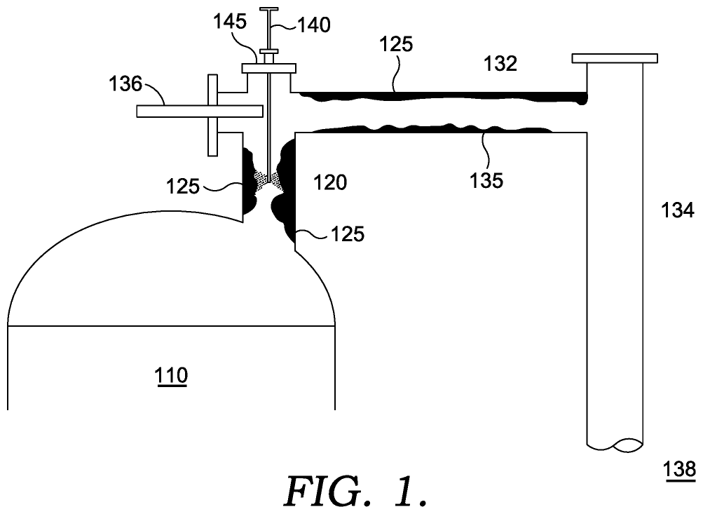

FIG. 1 schematically shows an example of a portion of a coker drum, a fractionator for separating vapor products generated in the coker drum, and a coke drum vapor line to provide fluid communication between the coke drum and the fractionator. Commercially, a plurality of coker drums can be associated with a given fractionator. This can allow the fractionator to be used with greater efficiency, as at least one coke drum can be used to perform delayed coking while one or more additional coke drums are having coke removed to allow further use.

In FIG. 1, a delayed coking process can be performed in coke drum 110. The coke drum line provides fluid communication between coke drum 110 and the entrance 138 to a fractionator (not shown). The coke drum line includes initial portion 120, and one or more additional portions, such as additional portion 132 and second additional portion 134. In some aspects, the distinction between portions of the coke drum vapor line can be based on the location of angular bends in the coke drum vapor line, such as the right angle bend between initial portion 120 and additional portion 132.

During a delayed coking process, coke accumulates in coke drum 110 while product vapors exit the coke drum 110 via an initial portion 120 of a coke drum vapor line. Coke also deposits on the inner walls of the coke drum vapor line, such as accumulated coke 125 in initial portion 120 of the coke drum vapor line, or additional coke 135 in additional portion 132 of the coke drum vapor line. FIG. 1 also shows an oil quench line 136 that can be used to add a hydrocarbon quench stream during operation of the delayed coker to reduce or minimize coking within the coke drum vapor line.

After performing coking for a period of time, a sufficient amount of coke can build up in coke drum 110 and the coking process can be stopped to allow for coke removal from coke drum 110. At the beginning of the coke drum decoking phase, steam can be injected into coke drum 110, during which the cracking reactions can further progress and vapor products are stripped from the coke bed. This is followed by injection of liquid water quench to cool the coke bed. After this quenching, the liquid water is drained to allow for removal of the coke bed in the coke drum 110 via high-pressure hydraulic decoking. When feeding heavy oil at cracking temperatures and forming coke in the drum, many cokers add quench oil (quench oil line 136) to slow the thermal cracking reaction kinetics, which reduces coke deposition downstream of piping portions 120, or in additional portions 132 and 134. This quench flow is typically maintained until vapor flow is directed to the coker blowdown system.

During the quench and/or draining phase of coke removal from coke drum 110, lance 140 can be inserted into the coke drum vapor line via port 145. After insertion, water can be sprayed at high pressure from one or more nozzles on the lance 140 to break up coke 125 on the walls of initial portion 120 of the coker drum vapor line. The water from lance 140 and coke particles or pieces formed during removal of coke 125 can fall back into coker drum 110. After removal of at least a portion of coke 125, the lance 140 can be retracted back through port 145 by a sufficient amount, so that the lance is substantially not in the flow path of the coke drum vapor line and/or the lance is in a purged recess that reduces or minimizes contact with process vapors. This can reduce or minimize the likelihood of coke forming on a surface of the lance and thereby sealing one or more of the nozzles on the lance.

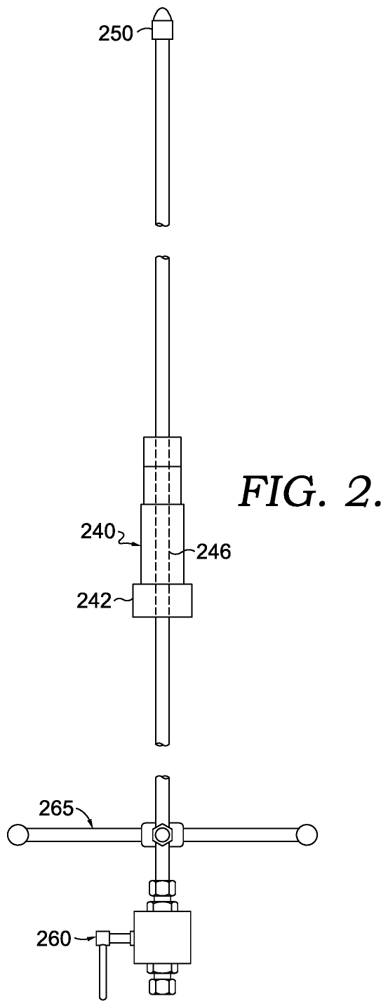

FIG. 2 shows additional details of a potential lance configuration. The configuration shown in FIG. 2 corresponds to lance with a handle for manual operation. In some aspects, a lance can be configured for automated insertion and rotation. In the configuration shown in FIG. 2, lance 246 includes a spray tip 250. Additionally or alternately, any other convenient type of opening to allow for discharge of high pressure water can be used as part of a lance. Ball valve 260 can be opened to allow high pressure water to be passed into spray tip 250 for use in coke removal. The spray tip and/or other portions of the lance can include any convenient number of nozzles or other openings for ejection of high pressure streams of water again desired surfaces with a coke layer. The nozzles or openings can be oriented at any convenient angle. When not in use, lance 240 (including spray tip 250) can be retracted within packing gland 240, such as by using handle 265 to reposition lance 240. Packing gland 246 also includes gland cap 242.

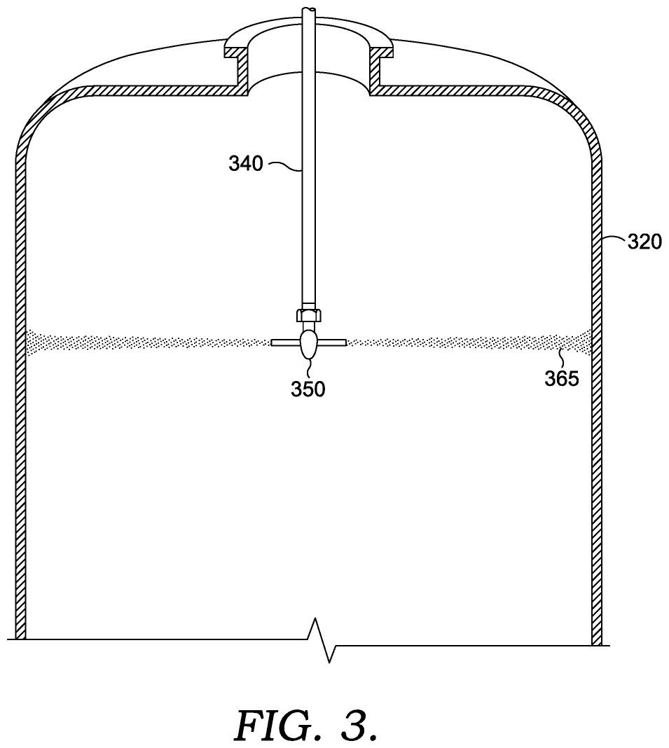

During operation, one or more high pressure water streams 365 can be sprayed from nozzles in spray tip 350 of lance 340, as shown in FIG. 3. In FIG. 3, the lance 340 is inserted vertically into a conduit 320, similar to the configuration shown in FIG. 1 for lance 140 in initial conduit 120 of the coke drum vapor line. In some alternate configurations, a lance can be inserted along another axis, such as a horizontal axis. This could allow, for example, for removal of coke from a portion of a coke drum vapor line that is oriented similar to additional portion 132 in FIG. 1. In such a configuration, an exit valve or port for removal of coke and water from additional portion 132 of the coke drum vapor line may be needed, as it would not typically be desirable to have water and coke particles wash into a fractionator or other separation stage.

### General Delayed Coking Conditions

Delayed coking is a process for the thermal conversion of heavy oils such as petroleum residua (also referred to as “resid”) to produce liquid and vapor hydrocarbon products and coke. Delayed coking of resids from heavy and/or sour (high sulfur) crude oils is carried out by converting part of the resids to more valuable hydrocarbon products. The resulting coke has value, depending on its grade, as a fuel (fuel grade coke), electrodes for aluminum manufacture (anode grade coke), etc.

Generally, a residue fraction, such as a petroleum residuum feed is pumped to a pre-heater where it is pre-heated, such as to a temperature from 480° C. to 520° C. (896 to 968° F.). The pre-heated feed is conducted to a coking zone, typically a vertically-oriented, insulated coker vessel, e.g., drum, through an inlet at the base of the drum. Pressure in the drum is usually relatively low, such as ˜100 kPa-g (15 psig) to ˜550 kPa-g (80 psig), or ˜100 kPa-g (15 psig) to ˜240 kPa-g (35 psig) to allow volatiles to be removed overhead. Typical operating temperatures of the drum will be between roughly 400° C. to 445° C. (752 to 833° F.), but can be as high as 475° C. (887° F.). The hot feed thermally cracks over a period of time (the “coking time”) in the coke drum, liberating volatiles composed primarily of hydrocarbon products that continuously rise through the coke bed, which consists of channels, pores and pathways, and are collected overhead. The volatile products are conducted to a coker fractionator for distillation and recovery of coker gases, gasoline boiling range material such as coker naphtha, light gas oil, and heavy gas oil. In an embodiment, a portion of the heavy coker gas oil present in the product stream introduced into the coker fractionator can be captured for recycle and combined with the fresh feed (coker feed component), thereby forming the coker heater or coker furnace charge. In addition to the volatile products, the process also results in the accumulation of coke in the drum. When the coke drum is full of coke, the heated feed is switched to another drum and hydrocarbon vapors are purged from the coke drum with steam. The drum is then quenched with water to lower the temperature down to ˜95° C. (200° F.) to ˜150° C. (˜300° F.), after which the water is drained. When the draining step is complete, the drum is opened and the coke is removed by drilling and/or cutting using high velocity water jets (“hydraulic decoking”).

A typical petroleum charge stock suitable for processing in a delayed coker can have a composition and properties within the ranges set forth below in Table 1.

TABLE 1
Example of Coker Feedstock

| | | |
|---|---|---|
| Conradson Carbon | 5 to 40 | wt. % |
| API Gravity | −10 to 35° | |
| Boiling Point | 340° C.+ to 690° C.+ | |
| | (644° F.+ to 1275° F.+) | |
| Sulfur | 1.5 to 8 | wt. % |
| Hydrogen | 9 to 11 | wt. % |
| Nitrogen | 0.2 to 2 | wt. % |
| Carbon | 80 to 86 | wt. % |
| Metals | 1 to 2000 | wppm |

More generally, the feedstock to the coker can have a T10 distillation point of 343° C. (650° F.) or more, or 371° C. (700° F.) or more. In some aspects, the coking conditions can be selected to provide a desired amount of conversion relative to 343° C. (650° F.). Typically a desired amount of conversion can correspond to 10 wt % or more, or 50 wt % or more, or 80 wt % or more, such as up to substantially complete conversion of the feedstock relative to 343° C. (650° F.).

Conventional coke processing aids can be used, including the use of antifoaming agents. The process is compatible with processes which use air-blown feed in a delayed coking process operated at conditions that will favor the formation of isotropic coke.

The volatile products from the coke drum are conducted away from the process for further processing. For example, volatiles can be conducted to a coker fractionator for distillation and recovery of coker gases, coker naphtha, light gas oil, and heavy gas oil. Such fractions can be used, usually, but not always, following upgrading, in the blending of fuel and lubricating oil products such as motor gasoline, motor diesel oil, fuel oil, and lubricating oil. Upgrading can include separations, heteroatom removal via hydrotreating and non-hydrotreating processes, de-aromatization, solvent extraction, and the like. The process is compatible with processes where at least a portion of the heavy coker gas oil present in the product stream introduced into the coker fractionator is captured for recycle and combined with the fresh feed (coker feed component), thereby forming the coker heater or coker furnace charge. The combined feed ratio (“CFR”) is the volumetric ratio of furnace charge (fresh feed plus recycle oil) to fresh feed to the continuous delayed coker operation. Delayed coking operations typically employ recycles of 5 vol % to 35% vol % (CFRs of about 1.05 to about 1.35). In some instances there can be no recycle and sometimes in special applications recycle can be up to 200%.

### ADDITIONAL EMBODIMENTS

### Embodiment 1

A method for performing coke removal, comprising: exposing a feedstock to delayed coking conditions in a coke drum of a coking reaction system comprising the coke drum, a coke drum vapor line, and a separation stage, the coke drum vapor line providing fluid communication between the coke drum and the separation stage, the delayed coking conditions resulting in coke formation in at least an initial portion of the coke drum vapor line; injecting, after the exposing, steam into the coke drum; introducing, after the exposing, cooling water into the coke drum; draining at least a portion of the cooling water from the coke drum; inserting a hydro-lance into the initial portion of the coke drum vapor line, the hydro-lance comprising one or more nozzles, openings, or a combination thereof and contacting the coke formed in the initial portion of the coke drum vapor line with water sprayed from the one or more nozzles, openings, or a combination thereof, the water being sprayed at a pressure of 17 MPa-g (2500 psig) or more and a flow rate of 19 liter/min (5 gpm) or more, wherein the contacting of the coke is at least partially performed during the injecting of steam, during the introducing of the cooling water, during the draining, or a combination thereof.

### Embodiment 2

The method of Embodiment 1, further comprising retracting the hydro-lance from the coke drum vapor line prior to a subsequent exposing of feedstock to delayed coking conditions in the coke drum, the hydro-lance optionally being retracted through a packing gland.

### Embodiment 3

The method of any of the above embodiments, wherein the contacting comprises forming coke pieces, coke particles or a combination thereof from the coke formed in the initial portion of the coke drum vapor line, and wherein the coke pieces, coke particles, or a combination thereof and at least a portion of the sprayed water enter the coke drum after the contacting.

### Embodiment 4

The method of any of the above embodiments, wherein the delayed coking conditions result in coke formation in one or more additional portions of the coke drum vapor line, the one or more additional portions of the coke drum vapor line being separated from the initial portion of the coke drum vapor line by at least one angular bend in the coke drum vapor line, and wherein the method further comprises: inserting a second hydro-lance into at least one of the one or more additional portions of the coke drum vapor line; and contacting the coke formed in at least one additional portion of the coke drum vapor line with water sprayed from at least one nozzle, opening, or a combination thereof of the second hydro-lance to form additional coke pieces, additional coke particles, or a combination thereof.

### Embodiment 5

The method of any of the above embodiments, i) wherein the water is sprayed at a pressure of 17 MPa-g (˜2500 psig) or more and a flow rate of 19 liter/min (5 gpm) or more from each of a plurality of nozzles, openings, or a combination thereof; ii) wherein the water is sprayed at a pressure of 34 MPa-g (˜5000 psig) or more, wherein the water is sprayed at a flow rate of 38 liter/min (10 gpm) or more, or a combination thereof; or iii) a combination of i) and ii).

### Embodiment 6

The method of any of the above embodiments, wherein the hydro-lance comprises a rotatable spray tip, the rotatable spray tip comprising the one or more nozzles, openings, or combination thereof.

### Embodiment 7

The method of any of the above embodiments, wherein the hydro-lance is inserted along a central axis of the initial portion of the coke drum vapor line.

### Embodiment 8

The method of Embodiment 7, wherein the contacting further comprises modifying a height of the hydro-lance in the coke drum vapor line along the central axis during the contacting.

### Embodiment 9

The method of any of the above embodiments, wherein the coke drum vapor line comprises a first pressure drop of 10 kPa (˜1.5 psi) to 200 kPa (˜29 psi) at an end of the exposing, the coke drum vapor line comprising a second pressure drop that is 20% lower than the first pressure drop (or 40% lower) after the contacting.

### Embodiment 10

The method of any of the above embodiments, wherein the feedstock comprises a T10 distillation point of 343° C. (650° F.) or more, the coking conditions comprising 10 wt % or more conversion of the feedstock relative to 343° C. (650° F.); or wherein the coking conditions comprise a pressure of 100 kPa-g (˜15 psig) to 700 kPa-g (˜102 psig) and a temperature of 400° C. (752° F.) to 475° C. (887° F.); or a combination thereof.

### Embodiment 11

A delayed coking system, comprising: a coke drum comprising a feedstock inlet and a coke drum vapor outlet; a coke drum vapor line comprising an initial portion, one or more additional portions, and a coke drum vapor line outlet, the initial portion of the coke drum vapor line being in fluid communication with the coke drum vapor outlet; a packing gland to comprising a packing gland opening in a wall of the initial portion of the coke drum vapor line; a hydro-lance configured to move from a first position within the packing gland to one or more positions at least partially located within the initial portion of the coke drum vapor line by passing through the packing gland opening, the hydro-lance comprising one or more nozzles, openings, or a combination thereof; and a separation stage in fluid communication with the coke drum vapor line outlet, the coke drum vapor line providing fluid communication between the coke drum and the separation stage.

### Embodiment 12

The delayed coking system of Embodiment 11, further comprising: a second hydro-lance configured for insertion into at least one of the one or more additional portions of the coke drum vapor line.

### Embodiment 13

The delayed coking system of Embodiment 11 or 12, a) wherein the one or more nozzles, openings, or a combination thereof are rotatable about at least one axis; b) wherein the hydro-lance is movable along a central axis of the initial portion of the coke drum vapor line; or c) a combination of a) and b).

### Embodiment 14

The delayed coking system of any of Embodiments 11 to 13, wherein the initial portion of the coke drum vapor line is separated from the one or more additional portions of the coke drum vapor line by at least one angular bend.

### Embodiment 15

The delayed coking system of any of Embodiments 11-14 or the method of any of Embodiments 1-10, wherein the separation stage comprises a fractionator.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The present invention has been described above with reference to numerous embodiments and specific examples. Many variations will suggest themselves to those skilled in this art in light of the above detailed description. All such obvious variations are within the full intended scope of the appended claims.

1. A method for performing coke removal, comprising:
exposing a feedstock to delayed coking conditions in a coke drum of a coking reaction system comprising the coke drum, a coke drum vapor line, and a separation stage, the coke drum vapor line providing fluid communication between the coke drum and the separation stage, the delayed coking conditions resulting in coke formation in at least an initial portion of the coke drum vapor line;
injecting, after the exposing, steam into the coke drum;
introducing, after the exposing, cooling water into the coke drum;
draining at least a portion of the cooling water from the coke drum;
inserting a hydro-lance into the initial portion of the coke drum vapor line, the hydro-lance comprising one or more nozzles, openings, or a combination thereof; and
contacting the coke formed in the initial portion of the coke drum vapor line with water sprayed from the one or more nozzles, openings, or a combination thereof, the water being sprayed at a pressure of 17 MPa-g (˜2500 psig) or more and a flow rate of 19 liter/min (5 gpm) or more,
wherein the contacting of the coke is at least partially performed during the injecting of steam, during the introducing of the cooling water, during the draining, or a combination thereof.

2. The method of claim 1, further comprising retracting the hydro-lance from the coke drum vapor line prior to a subsequent exposing of feedstock to delayed coking conditions in the coke drum.

3. The method of claim 2, wherein the hydro-lance is retracted through a packing gland.

4. The method of claim 1, wherein the contacting comprises forming coke pieces, coke particles or a combination thereof from the coke formed in the initial portion of the coke drum vapor line, and wherein the coke pieces, coke particles, or a combination thereof and at least a portion of the sprayed water enter the coke drum after the contacting.

5. The method of claim 1, wherein the delayed coking conditions result in coke formation in one or more additional portions of the coke drum vapor line, the one or more additional portions of the coke drum vapor line being separated from the initial portion of the coke drum vapor line by at least one angular bend in the coke drum vapor line.

6. The method of claim 5, further comprising:
inserting a second hydro-lance into at least one of the one or more additional portions of the coke drum vapor line; and
contacting the coke formed in at least one additional portion of the coke drum vapor line with water sprayed from at least one nozzle, opening, or a combination thereof of the second hydro-lance to form additional coke pieces, additional coke particles, or a combination thereof.

7. The method of claim 1, wherein the water is sprayed at a pressure of 17 MPa-g (2500 psig) or more and a flow rate of 19 liter/min (5 gpm) or more from each of a plurality of nozzles, openings, or a combination thereof.

8. The method of claim 1, wherein the water is sprayed at a pressure of 34 MPa-g (5000 psig) or more, wherein the water is sprayed at a flow rate of 38 liter/min (10 gpm) or more, or a combination thereof.

9. The method of claim 1, wherein the hydro-lance comprises a rotatable spray tip, the rotatable spray tip comprising the one or more nozzles, openings, or combination thereof.

10. The method of claim 1, wherein the hydro-lance is inserted along a central axis of the initial portion of the coke drum vapor line.

11. The method of claim 10, wherein the contacting further comprises modifying a height of the hydro-lance in the coke drum vapor line along the central axis during the contacting.

12. The method of claim 1, wherein the coke drum vapor line comprises a first pressure drop of 10 kPa to 200 kPa (˜1.5 psi˜29 psi) at an end of the exposing, the coke drum vapor line comprising a second pressure drop that is 20% lower than the first pressure drop (or 40% lower) after the contacting.

13. The method of claim 1, wherein the feedstock comprises a T10 distillation point of 343° C. (˜650° F.) or more, the coking conditions comprising 10 wt % or more conversion of the feedstock relative to 343° C.; or wherein the coking conditions comprise a pressure of 100 kPa-g (˜15 psig) to 700 kPa-g (˜102 psig) and a temperature of 400° C. to 475° C. C (752° F. to 887° F.); or a combination thereof.

14. The method of claim 1, wherein the separation stage comprises a fractionator.

15. A delayed coking system, comprising:
a coke drum comprising a feedstock inlet and a coke drum vapor outlet;
a coke drum vapor line comprising an initial portion, one or more additional portions, and a coke drum vapor line outlet, the initial portion of the coke drum vapor line being in fluid communication with the coke drum vapor outlet;
a packing gland comprising a packing gland opening in a wall of the initial portion of the coke drum vapor line;
a hydro-lance configured to move from a first position within the packing gland to one or more positions at least partially located within the initial portion of the coke drum vapor line by passing through the packing gland opening, the hydro-lance comprising one or more nozzles, openings, or a combination thereof; and
a separation stage in fluid communication with the coke drum vapor line outlet, the coke drum vapor line providing fluid communication between the coke drum and the separation stage.

16. The delayed coking system of claim 15, further comprising: a second hydro-lance configured for insertion into at least one of the one or more additional portions of the coke drum vapor line.

17. The delayed coking system of claim 15, wherein the one or more nozzles, openings, or a combination thereof are rotatable about at least one axis.

18. The delayed coking system of claim 15, wherein the separation stage comprises a fractionator.

19. The delayed coking system of claim 15, wherein the initial portion of the coke drum vapor line is separated from the one or more additional portions of the coke drum vapor line by at least one angular bend.

20. The delayed coking system of claim 15, wherein the hydro-lance is movable along a central axis of the initial portion of the coke drum vapor line.
